(19) United States
(12) Patent Application Publication
(10) Pub. No.: US 2019/0056006 A1
(43) Pub. Date: Feb. 21, 2019

(54) MOTOR ASSEMBLY

(71) Applicant: Akebono Brake Industry Co., Ltd., Tokyo (JP)

(72) Inventors: Galus Chelaidite, South Lyon, MI (US); Michio Suzuki, Walled Lake, MI (US)

(21) Appl. No.: 15/973,580

(22) Filed: May 8, 2018

Related U.S. Application Data
(60) Provisional application No. 62/548,033, filed on Aug. 21, 2017.

(51) Int. Cl. F16D 65/18; F16D 55/226

(52) U.S. Cl. CPC F16D 65/18; F16D 2121/24; F16D 55/226

(57) ABSTRACT

A motor assembly that includes a motor, a first output, and a second output. The motor includes an output shaft and a motor housing. The first output in rotational communication with the output shaft such that the first output and the output shaft rotate together. The second output in rotational communication with the motor housing such that the second output and the motor housing rotate together. In a first condition, torque is transmitted to the first output such that the first output and the output shaft rotate together. In a second condition, torque is transmitted to the second output such that the second output and the motor housing rotate together. In a third condition, torque is transmitted to both of the first output and the second output such that the first output and the output shaft rotate together and the second output and the motor housing rotate together.

### FIELD

These teachings relate to a motor assembly, and more particularly to a motor assembly that is adapted to generate and transfer torque to a first output, a second output, or to both the first and second outputs.

### BACKGROUND

A brake assembly typically includes a brake caliper that is adapted to support at least one brake piston. The brake piston is adapted to move at least one brake pad against a moving component to create a clamping force. The clamping force may be used to slow, stop, or prevent movement of the moving component. In vehicular applications, the moving component may be a brake rotor.

Some vehicles, like trucks, vans, SUVs, and high-performance vehicles, have brake assemblies that include two or more brake pistons that are adapted to move one or more brake pads against a brake rotor to create the clamping force to slow, stop, or prevent movement of the brake rotor and thus the vehicle. In some of these applications, each of the brake pistons may be moved with a single, discrete electric motor. As can be imagined, moving each brake piston with a discrete electric motor may undesirably add cost, weight, and/or complexity to the system, and/or may require a larger packaging space to accommodate all of the individual motors.

In other applications, a single electric motor may be adapted to move two or more brake pistons; however, in these applications, an ancillary gear system or torque transferring device may be required between the single motor and each of the two or more brake pistons so that the torque from the motor can be distributed to each of the brake pistons. As can be imagined, such ancillary systems may undesirably add cost, weight, and/or complexity to the system, and/or may undesirably require a larger packaging space to accommodate the ancillary gear system.

Therefore, to improve braking performance, while also being mindful of weight, cost, complexity, and packaging space, in some vehicle platforms, it may be desirable to have a brake assembly where a plurality of brake pistons can be moved with a single motor without requiring a complicated ancillary gear or torque transferring system between the motor and each of the brake pistons.

While a large capacity, or a high-output motor may be considered by some to move a plurality of brake pistons to create a sufficient clamping force, a large or high-output motor may not reduce weight, cost, and packaging space. Thus, it may also be advantageous to have a motor assembly that can move a plurality of brake pistons to create a sufficient clamping force without resorting to using a large capacity or high-output motor.

Some examples of motor assemblies are disclosed in U.S. Pat. No. 6,433,451; U.S. Pat. No. 7,262,553; U.S. Pat. No. 9,276,453; and WO 2008/065647, each of which are hereby incorporated by reference herein for all purposes.

### SUMMARY

These teachings provide a motor assembly that is adapted to generate torque, and then transfer the torque to a first output, a second output, or to both a first and second output. That is, depending on the load acting on, or applied to, a particular output of the motor assembly, the torque generated by the motor is transferred by the motor assembly to either the first output; to the second output; or to both the first and second outputs.

Advantageously, the motor assembly according to the teachings herein can be adapted to move only a first output; only a second output; or both outputs at the same time, depending on the load acting on, or applied to, each output of the motor assembly. Also, when both outputs are moved at the same time, one of the outputs may rotate faster than another output, and/or more torque may be transmitted from the motor to one of the outputs compared to another one of the outputs.

These teachings provide a motor assembly that includes a motor, a first output, and a second output. The motor includes an output shaft and a motor housing. The first output in rotational communication with the output shaft such that the first output and the output shaft rotate together. The second output in rotational communication with the motor housing such that the second output and the motor housing rotate together. In or during a first condition, torque is transmitted to the first output such that the first output and the output shaft rotate together. In or during a second condition, torque is transmitted to the second output such that the second output and the motor housing rotate together. In or during a third condition, torque is transmitted to both of the first output and the second output such that the first output and the output shaft rotate together and the second output and the motor housing rotate together.

These teachings provide a motor assembly comprising: a motor comprising an output shaft and a motor housing; a first output in rotational communication with the output shaft such that the first output and the output shaft rotate together; and a second output in rotational communication with the motor housing such that the second output and the motor housing rotate together. The motor is adapted to generate torque that is transmitted to: the first output, such that the first output and the output shaft rotate together; the second output, such that the second output and the motor housing rotate together; or to both of the first output and the second output, such that the first output and the output shaft rotate together and the second output and the motor housing rotate together. When a load acting on the first output becomes higher than a load acting on the second output, the first output slows or ceases to rotate, while the second output continues to rotate. When the load acting on the second output becomes higher than the load acting on the first output, the second output slows or ceases to rotate, while the first output continues to rotate. During a free running condition when the load acting on the first output is substantially the same as the load acting on the second output, both of the first output and the second output rotate. During the free running condition, the first output rotates faster than the second output. The first output and the second output rotate in opposing directions. A brake assembly may comprise the motor assembly according to the teachings herein. The motor may be a brush motor or a brushless motor.

These teachings also provide a motor assembly, comprising: a motor; a first output; and a second output. The motor is adapted to generate torque that is transmitted to both of the first output and the second output so that both of the first output and the second output rotate. When a load at one of the first output and the second output becomes higher than a load at the other one of the first output and the second output, the output with the higher load slows or ceases to rotate, while the output with the lower load continues to rotate. The first output and the second output rotate in opposite directions. The motor comprises an output shaft, the output shaft is in rotational communication with the first output. When the load at the first output is lower than the load at the second output, the output shaft rotates with the first output. The motor comprises a motor housing, the motor housing is in rotational communication with the second output. When the load at the second output is lower than the load at the first output, the motor housing rotates with the second output. During a free running condition when the load at the first output is generally the same as the load at the second output, the first output and the second output both rotate. During the free running condition, the first output rotates faster than the second output. A vehicle brake assembly may comprise the motor assembly according to the teachings herein.

These teachings further provide a brake assembly, comprising: a brake caliper, a first brake piston; a second brake piston; and a motor assembly. The motor assembly comprises a motor comprising an output shaft and a motor housing; a first output in rotational communication with the output shaft, the first output is adapted to move the first brake piston, and a second output in rotational communication with the housing, the second output is adapted to move the second brake piston. The motor is adapted to generate torque that is transmitted to both of the first output and the second output so that the first output moves the first brake piston and the second output moves the second brake piston. When a load at one of the first output and the second output becomes higher than a load at the other one of the first output and the second output, the output with the higher load slows or ceases to rotate so that the corresponding first brake piston or second brake piston ceases to be moved, while the output with the lower load continues to rotate so that the corresponding first brake piston or second brake piston continues to be moved. When the load is lower at the first output, the output shaft rotates with the first output. When the load is lower at the second output, the motor housing rotates with the first output. The first brake piston and the second brake piston are arranged on a common side of a brake rotor. The first brake piston is adapted to move a first end of a brake pad towards the brake rotor, and the second brake piston is adapted to move a second end of the brake pad towards the brake rotor. The first brake piston and the second brake piston are arranged on opposing sides of a brake rotor. The first brake piston is adapted to move a first brake pad towards a side of the brake rotor, and the second brake piston is adapted to move a second brake pad towards an opposing side of the brake rotor. During a free running condition when the load at the first output is generally the same as the load at the second output, the first output and the second output both rotate. During the free running condition, the first output and the output shaft rotate faster than the second output and the motor housing.

### BRIEF DESCRIPTION OF THE DRAWINGS

FIG. 1 is a cross-sectional view of a brake assembly.

FIG. 2 is a cross-sectional view of another brake assembly.

FIG. 3 is a perspective view of a motor assembly for use with the brake assembly of FIG. 1 and/or FIG. 2.

FIG. 4 is a cross-sectional view of the motor assembly of FIG. 3.

### DETAILED DESCRIPTION

The motor assembly may function to generate torque. The motor assembly may function to transfer the generated torque to one or more destinations. The motor assembly may function to transfer or distribute the generated torque to one or more destinations depending on the operating condition. For example, depending on the load acting on or applied to one or more of the outputs or destinations, the motor assembly may function to transfer or distribute the torque to a first destination via the first output; to a second destination via the second output; or to both the first and second outputs via the respective first and second outputs.

More specifically, during one or more of the operating conditions when a load acting on or applied to a first output is greater than a load acting on or applied to the second output, the motor assembly may function to distribute or transfer some or all of the torque to the second output where the load is less. Conversely, during one or more of the operating conditions when a load acting on or applied to a second output is greater than a load acting on or applied to the first output, the motor assembly may function to transfer some or all of the torque to the first output where the load is less. When the load acting on or applied to the first output is substantially the same as the load acting on or applied to the second output, the motor assembly may function to transfer the torque to both the first and second outputs.

The motor assembly may perform the aforementioned functions without a differential or other ancillary, external gearing or torque transfer mechanism or means. That is, the motor assembly may be free of a differential assembly or other transferring or distributing mechanism for transferring, providing, or supplying the torque generated by the motor to one or more outputs or destinations. In other words, torque generated by the motor may be provided directly to one or both of the outputs and then to one or more destinations without being transferred with or between any intervening gears, gear trains, transfer devices, differentials, or the like.

Advantageously, the motor assembly according to the teachings herein provides a simplified and cost-effective assembly for transferring torque. Accordingly, packaging space, cost, and/or system complexity can be reduced.

While the motor assembly disclosed herein may be suitable for vehicular brake assemblies, it is understood that other non-vehicular and/or non-brake applications may benefit from having a motor assembly according to these teachings. That is, virtually any application where it is desirable to transfer torque from a motor to one or more outputs or destinations may benefit from the teachings herein. For example, the motor assembly may be incorporated into a lathe, a winder for paper products or cloth, amusement park rides, wind turbines, or the like.

Furthermore, various vehicular, non-braking type of applications may benefit from these teachings. For example, the motor assembly according to these teachings may be incorporated into an electric or hybrid motor vehicle and used to distribute torque to the road wheels. For example, one motor assembly may be adapted to transfer torque to the front two wheels, and/or one motor assembly may be adapted to transfer torque to the rear two wheels.

The motor assembly may comprise a motor. The motor may function to create or generate torque. The motor may be a DC motor. The motor may be an AC motor. The motor may be a brush motor. The motor may be a brushless motor. The motor may be a series-wound motor, a shunt wound motor, a compound wound motor, a separately exited motor, a servomotor, a stepping motor, or a permanent magnet motor. The motor may be virtually any motor that generates torque.

The motor may include one or more terminals for connecting the motor or the motor assembly to a power source, a controller, a computer, or a combination thereof. The power source, controller, and/or computer may function to control the motor and/or the motor assembly. For example, the power source, controller, and/or computer may function to turn the motor ON and OFF; may function to set or adjust a speed or torque output of the motor; or a combination thereof.

The motor assembly may comprise a motor housing. The motor housing is adapted to support the components of the motor assembly. For example, the motor housing may function to support the motor, the rotor or armature, the stator or permanent magnets, the commutator, etc. The motor housing may be adapted to rotate. The motor housing may be adapted to rotate about an axis that is the same as an axis about which the output shaft of the motor rotates. The motor housing and the output shaft may be adapted to rotate in opposing directions. The motor housing may be adapted to rotate in a first or apply direction to generate or develop the clamping force, and then rotate in a second or release direction to release the clamping force. The first direction may be a clock-wise direction and the second direction may be a counter clock-wise direction, or vice versa. The motor housing may be supported or balanced on one or more bearings so that the motor housing can rotate. The motor housing may be supported in a main housing and free to rotate therein, and the main housing may be mounted to a non-moving portion of a vehicle and restricted or prevented from rotating. Alternatively, the motor housing may be exposed (i.e., not located within a main housing), but supported in such a way that allows for the motor housing to rotate. The motor housing may be connected to, attached to, or even integrally formed with one of the outputs so that the motor housing and the corresponding output always rotate together in the same direction.

The motor assembly or the motor may comprise an output shaft. The output shaft may be adapted to rotate. The output shaft and the motor housing may be adapted to rotate in opposing directions. The output shaft may be adapted to rotate in a first or apply direction to generate or develop the clamping force, and then rotate in a second or release direction to release the clamping force. The first direction may be a clock-wise direction and the second direction may be a counter clock-wise direction, or vice versa. The output shaft may be connected to attached or, or even integrally formed with one of the outputs so that the output and the output shaft always rotate together in the same direction. The output shaft may extend through an opening defined in the motor housing.

The motor assembly may comprise one or more outputs. The motor assembly may comprise two outputs. The torque generated by the motor may be transferred to one or both of the outputs.

An output may be any device or mechanism for transferring torque generated by the motor to a destination. An output may have suitable features for engaging a corresponding destination so that torque from the output can be transferred to the destination. For example, the output may have teeth, or splines, or may be in communication with a destination via a belt or chain. An output may be a gear.

One of the outputs may be in rotational communication with the output shaft, and one of the outputs may be in rotational communication with the motor housing. Rotational communication as used herein means that when the output shaft rotates the corresponding output also rotates. Rotational communication as used herein means that when the motor housing rotates the corresponding output also rotates. One of the outputs may be press fit, mechanically attached, or integrally formed with the output shaft. One of the outputs may be press fit, mechanically attached, or integrally formed with the motor housing. Additionally, or alternatively, a suitable adapter may facilitate attachment of a corresponding output with the output shaft or motor housing. The adapter may be a sleeve, for example, that ensures attachment or tight fit of the output and the motor housing or output shaft.

One or more of the outputs may be directly connected or in communication with a corresponding destination. Alternatively, one or more of the outputs may have one or more intervening gears or transfer devices provided between the output and the destination. The one or more intervening gears or transferring devices may function to transfer the torque from the output to the destination; increase torque from the output to the destination; decrease torque from the output to the destination. For example, one or more gears or gear train may be a 1:1 transfer, or the transfer may step up or step down the torque and/or speed from the output to the destination.

During operation of the motor assembly, because the outputs are adapted to rotate in opposite directions, during a brake apply to create the clamping force, one of the outputs may rotate in a clockwise direction, and another of the outputs may rotate in a counterclockwise direction. In this regard, one of the rotary to linear stage mechanisms or destinations should be threadably engaged such that rotation of the spindle in the clockwise direction causes the nut to advance in an apply direction towards the bottom wall of the bottom pocket wall. And, therefore, the other rotary to linear stage mechanism should be threadably engaged such that rotation of the spindle in the counter-clockwise direction causes the nut to advance in an apply direction towards the bottom wall of the bottom pocket wall.

Alternatively, a gear may be placed between one of the outputs and the destination so that even though the outputs rotate in opposite directions, both spindles can still be rotated in the same direction so that both nuts advance in an apply direction towards the bottom pocket wall so that the clamping force can be generated. Similarly, by including such a gear between one of the outputs and the destination, both spindles can be rotated in the same direction and cause the nut to retract in a release direction away from the bottom pocket wall so that the clamping force can be released, even though both outputs rotate in opposite directions.

During operation of the motor assembly, during one or more of the operating conditions when a load acting on or applied to a corresponding output increases compared to the load acting on or applied to the other output, the output with the higher load may slow or cease rotating. Accordingly, the output with the lower load acting on it may continue to rotate, begin rotating, or rotate faster than the other output. The outputs may rotate and then cease individually or together several times to generate sufficient clamping force. To release the clamping force, the outputs may rotate simultaneously, to unscrew the spindles so that the nuts move away from the bottom pocket wall of the brake piston at substantially the same time so that the brake pads move away from the brake rotor to release the clamping force. This may advantageously prevent cocking of the brake pad during release of the clamping force.

During operation of the motor assembly, when/as the load acting on or applied to the corresponding output increases, the motor assembly functions to transfer torque to the output with the lower load acting on it, which may be the output in communication with the other brake piston where the nut has not yet contacted the bottom pocket wall, or output corresponding to the other end of the brake pad that has not yet contacted the side of the brake rotor, or the output corresponding to the end of the brake pad has not yet developed a sufficient clamping force. When/as the load acting on or applied to the corresponding output increases, that output may slow or cease rotating, while the other output may continue to rotate or rotate faster, which continues to move the other nut or brake piston.

Each of the outputs may be in communication with a destination. A destination may be a feature that is adapted to be rotated by the motor. For example, the destination may be a rotary to linear stage mechanism, a gear train located between an output and the rotary to linear stage mechanism, a spindle, a nut, a brake piston, or any other like feature. For example, rotation of the output may cause a corresponding spindle destination to rotate.

The motor assembly may include one or more bearings. The bearings may function to facilitate rotation of the motor housing. The motor may be suspended and mounted on one or more of the bearings.

The motor assembly may include a slip ring. The slip ring may function to supply power, one or more communication signals, or both to the motor, the motor assembly, or both. The slip ring may contain the number of windings if the motor is a brushless motor. The slip ring may contain sensors for motor operation. The slip ring may contain the terminals or contacts for supplying the motor with power, operating signals or both. The slip ring may be stationary while the motor housing and/or output shaft rotate.

The brake assembly may be any system or assembly for creating a clamping force. The brake assembly may function to create a clamping force and/or a brake apply to slow, stop, and/or maintain a moving component, such as a road wheel or a vehicle in a stopped position. The brake assembly may function to release a clamping force and/or a brake apply so that a moving component, such as a road wheel or a vehicle can move. For example, the brake assembly may be an opposing brake system (i.e., a fixed caliper brake system) or a floating brake system (i.e., a floating caliper). The brake assembly may be a disc brake system. The brake assembly may be used as a service brake. The brake assembly may be used as a parking brake.

Clamping force may be any force that, when coupled with a brake pad coefficient of friction, functions to decelerate, slow, stop, and/or prevent movement or rotation of a brake rotor, a road wheel, and/or a vehicle. The clamping force may be created during a standard brake apply or application of the service brake (i.e., a brake apply force) to slow, stop, or prevent movement of a road wheel or vehicle. The clamping force may be created during a parking brake apply (i.e., a parking brake force) to prevent or restrict movement of a stopped or parked road wheel or vehicle.

The brake assembly may comprise a brake caliper. The brake caliper may function to support one or more the components of the brake assembly. For example, the body caliper may comprise one or more pistons or piston assemblies to clamp one or more brake pads. The brake caliper may provide for one or more brake pads, or, preferably, two or more brake pads to move relative to the brake rotor. The brake caliper may move during a brake apply (i.e., a floating caliper), or the brake caliper may be fixed so that the brake caliper does not move during a brake apply (i.e., a fixed caliper). The brake caliper may be connected or mounted to any non-rotating or moving part of a vehicle, like a knuckle or a spider (i.e., a fixed caliper). The brake caliper may be connected or mounted to any non-rotation or moving part of vehicle via a mounting support (i.e., a floating caliper), which may be the casting that a disc brake or drum-in-hat system is mounted to.

The brake caliper may comprise one or more piston bores. A piston bore may define a hollow region in the brake caliper that is configured to receive and support a corresponding brake piston. A brake caliper can have one piston bore. A brake caliper can have two or more piston bores. One or more piston bore(s) can be located on only one side of the brake rotor, or one or more piston bores can be located on both sides of the brake rotor.

The brake assembly may include one or more brake pistons. The one or more brake pistons may function to be moved which in turn causes a brake pad, or a corresponding end of brake pad, to move towards a brake rotor to create the clamping force. The one or more brake pistons can be moved by pressurizing or depressurizing fluid, such as brake fluid. The one or more brake pistons can be mechanically moved, for example, with one or more rotary to linear stage mechanisms; spindles; nuts; etc. The one or more brake pistons may be moved with the torque generated by the motor and transferred or supplied to the brake piston via a corresponding output.

Each brake piston may include a piston pocket. The piston pocket may be a cup or recess formed into an end of a brake piston. The piston pocket may receive at least a portion of a corresponding rotary to linear stage mechanism. The piston pocket may include a bottom wall at the end or bottom of the piston pocket. A gap may be defined or may exist between the nut of the rotary to linear stage mechanism and a corresponding bottom wall of the piston pocket.

During a brake apply, whether during application of the service brake or the parking brake, the gap may be taken up by moving the nut towards the bottom wall. The nut may be moved towards the bottom pocket wall by rotating the corresponding spindle that is threadably connected to the nut. The spindle may be rotated by a corresponding output of the motor assembly. Once the gap is taken up or eliminated, further movement of the nut or rotary to linear stage mechanism may cause the nut to press against the bottom wall and then move the brake piston, and thus brake pad against the brake rotor to create the clamping force.

After the nut contacts the bottom pocket wall, the load that acts on or is applied to the corresponding output may increase. When/as the load acting on or applied to the corresponding output increases, the motor assembly functions to transfer torque to the output with the lower load acting on it, which may be the output in communication with the other brake piston where the nut has not yet contacted the bottom pocket wall, or output corresponding to the other end of the brake pad that has not yet contacted the side of the brake rotor, or the output corresponding to the end of the brake pad has not yet developed a sufficient clamping force. When/as the load acting on or applied to the corresponding output increases, that output may slow or cease rotating, while the other output may continue to rotate or rotate faster, which continues to move the other nut or brake piston.

The brake assembly may comprise one or more rotary to linear stage mechanisms. A rotary to linear stage mechanism may function to transfer or convert torque from the motor or motor assembly or corresponding output of the motor assembly into a linear or axial force to axially move one or more destinations, such as the one or more brake pistons. The one or more rotary to linear stage mechanisms may be a high-efficiency device, such as a ball screw or a roller screw for example. However, the one or more rotary to linear stage mechanisms may be a low-efficiency device. Each of the one or more rotary to linear stage mechanisms may generally include a spindle and a nut.

A spindle may be rotated by a corresponding output, or a gear train, or other gear located between the spindle and a corresponding output of the motor assembly. The spindle may be rotated in an apply direction and a release direction to apply and release the parking brake, respectively. The apply direction may be a clockwise direction, and the release direction may be a counter-clockwise direction, or vice versa.

As was discussed above, because the first output and the second output are adapted to rotate in opposite directions during a brake apply, one of the spindles may be adapted to rotate in a first direction to move the nut towards the bottom pocket wall of a respective brake piston to create the clamping force, and another one of the spindles may be adapted to rotate in a second, opposing direction to move the nut towards the bottom pocket wall of a respective brake piston to create the clamping force. In other words, one of the spindles should have a reverse thread with the mating nut. Alternatively, a gear or gear train may be disposed between one of the outputs and the corresponding spindle so that while both outputs rotate in opposite directions, the spindles can be rotated in the same direction to create the clamping force.

The same may be true when releasing the clamping force. That is, because the first output and the second output adapted to rotate in opposite directions during release of the brake apply, one of the spindles should be adapted to rotate in a first direction to move the nut away from the bottom pocket wall of a respective brake piston to release the clamping force, and another one of the spindles should be adapted to rotate in a second, opposing direction to move the nut away from the bottom pocket wall of a respective brake piston to release the clamping force. In other words, one of the spindles should have a reverse thread with the mating nut. Alternatively, a gear or gear train may be disposed between one of the outputs and the corresponding spindle so that while both outputs rotate in opposite directions, the spindles can be rotated in the same direction to release the clamping force.

The nut may be moved axially along an axis that the spindle rotates about. The nut and the spindle may be threadably engaged such that when the spindle is rotated by the motor assembly or the corresponding output, the nut moves axially toward or away from a bottom wall of the piston pocket depending if the corresponding spindle is rotated in an apply or release direction. After contact between the nut and the piston pocket wall occurs, further movement of the nut in the apply direction may result in movement of a brake piston and thus a brake pad, or a corresponding end of a brake pad towards a brake rotor. After the contact is made between the nut and the bottom pocket wall of the piston pocket, the load acting on or applied on the corresponding output may increase, which may result in that output slowing or ceasing to rotate, while the other output with the lower load acting on it continuing to rotate, or even rotating faster.

One or more brake pads may be used in the brake assembly. Each brake pad includes a friction material and a pressure plate. The one or more brake pads may be supported on a mounting support so that the friction material faces a side of the brake rotor. The pressure plate may oppose the friction surface. One or more brake pistons, or one or more brake caliper fingers, may contact the pressure plate of a corresponding brake pad. For example, in some cases, one or more brake pistons may be in contact with the pressure plate of an inboard brake pad, and one or more brake caliper fingers may be in contact with the pressure plate of an outboard brake pad. In some cases, one or more brake pistons may be in contact with the pressure place of an inboard brake pad, and one or more brake pistons may be in contact with the pressure place of an outboard brake piston. During a brake apply, or while applying the parking brake, the one or more brake pistons and/or the one or more fingers can move all or an end of a corresponding brake pad so that the corresponding friction material engages a corresponding side of the brake rotor to create the clamping force.

The brake assembly may comprise a brake rotor. The brake rotor is the rotating part the brake assembly, against which one or more of the brake pads are moved or applied to create the clamping force.

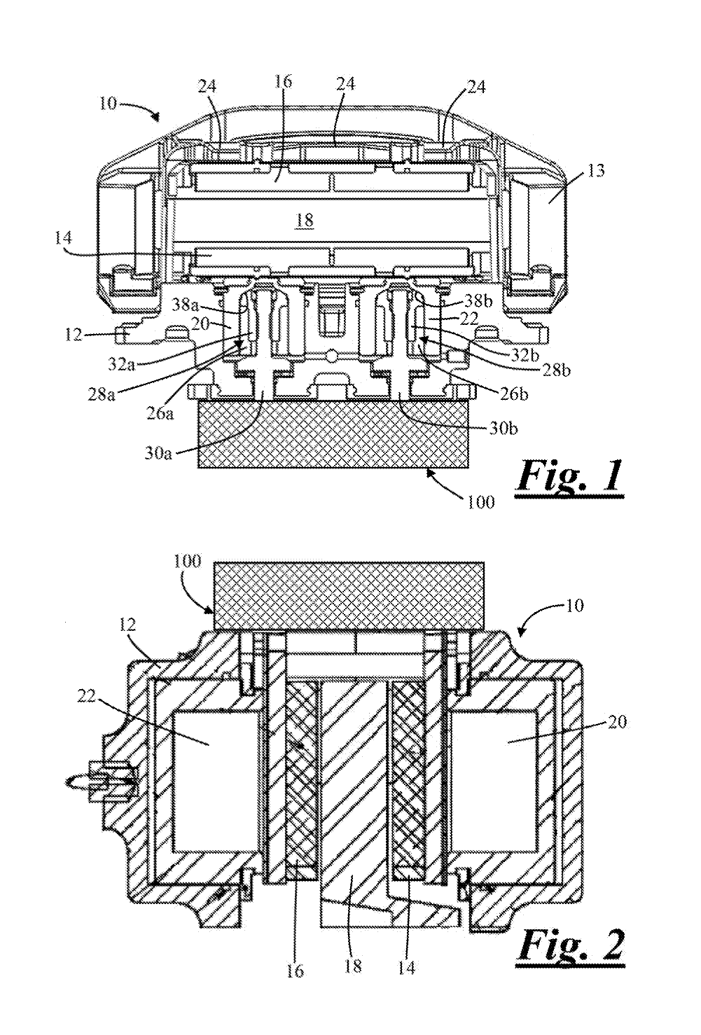

FIG. 1 illustrates a brake assembly 10, that is a floating-type of disc brake. The brake assembly 10 comprises a brake caliper 12 and a mounting support 13 that is adapted to support an inboard brake pad 14 and an outboard brake pad 16. The brake pads 14, 16 are arranged on opposing sides of a brake rotor 18. The brake caliper 12 includes two brake pistons, namely a first brake piston 20 and a second brake piston 22. Both of the brake pistons 20, 22 are located on an inboard side of the brake caliper 12 relative to the brake rotor 18 and adjacent the inboard brake pad 14. The brake caliper 12 includes fingers 24 that are in contact with the outboard brake pad 16.

Each of the first brake piston 20 and the second brake piston 22 comprises a piston pocket 26a, 26b. Each piston pocket 26a, 26b comprises a corresponding bottom pocket wall 38a, 38b. Inside each piston pocket 26a, 26b is a corresponding rotary to linear stage mechanism 28a, 28b that comprises a spindle 30a, 30b and a nut 32a, 32b.

A motor assembly 100 is adapted to generate torque, which, as will be described further below, is used to move the first brake piston 20, the second brake piston 22, or both brake pistons 20, 22. Movement of one or both of the brake pistons 20, 22 causes the inboard brake pad 14 to be moved or pushed against the brake rotor 18 and, via a reaction force, the second brake pad 16 to be moved or pulled against the brake rotor 18 to create a clamping force.

FIG. 2 illustrates a brake assembly 10, that is an opposed-piston-type of disc brake. The brake assembly 10 comprises a brake caliper 12 that supports a first brake pad 14 and a second brake pad 16. The brake pads 14, 16 are supported on opposing sides of a brake rotor 18. The brake caliper 12 includes two brake pistons, namely a first brake piston 20 and a second brake piston 22. The brake pistons 20, 22 are located on opposing sides of the brake rotor 18 and adjacent the corresponding brake pads 14, 16. While not illustrated, each of the brake pistons 20, 22 include a piston pocket with a bottom pocket wall. While also not illustrated, inside each piston pocket may be a corresponding rotary to linear stage mechanism that comprises a spindle and a nut, like those illustrated and described above in FIG. 1.

A motor assembly 100 is adapted to generate torque, which, as will be described further below, is used to move the first brake piston 20, the second brake piston 22, or both brake pistons 20, 22. Movement of the first brake piston 20 causes the first brake pad 14 to be moved or pushed against the brake rotor 18 to create a clamping force, and movement of the second brake piston 22 causes the second brake pad 16 to be moved or pushed against the brake rotor 18 to create a clamping force.

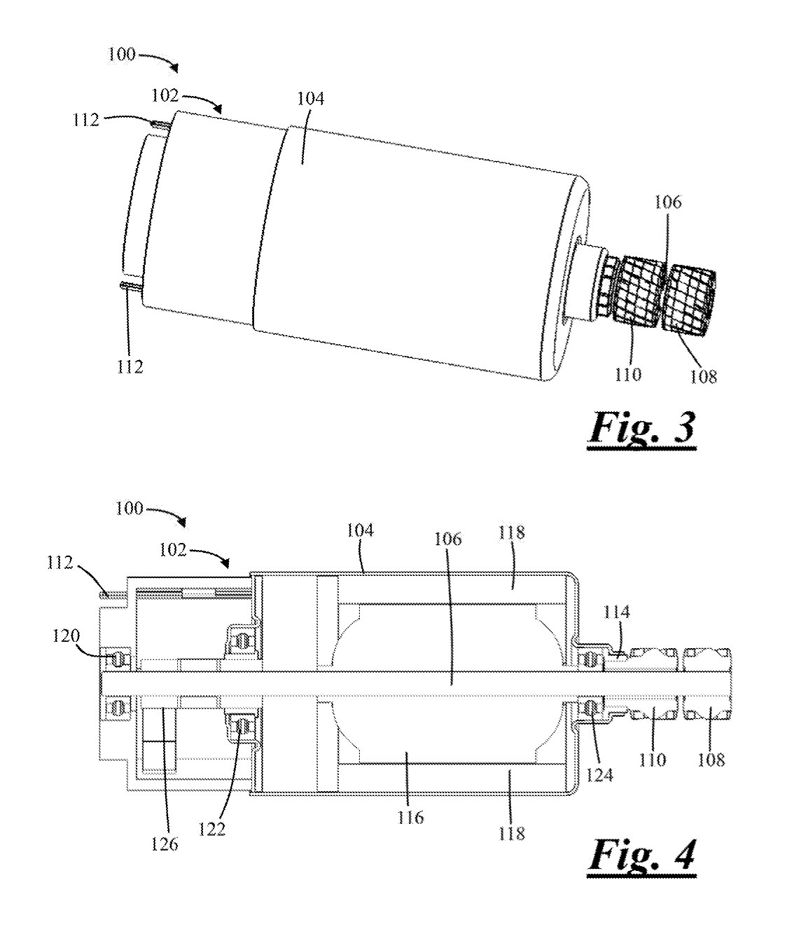

FIG. 3 illustrates the motor assembly 100. The motor assembly 100 comprises a motor 102, a motor housing 104, an output shaft 106, a first output 108, and a second output 110.

The motor assembly 100 comprises one or more terminals 112 for providing power to the motor 102 and/or for providing signals to the motor 102 to control the motor 102 and the motor assembly 100. For example, a power source and/or a controller (not illustrated) may be in communication with one or more of the terminals 112 for turning the motor 102 ON and OFF, and for controlling the torque output direction of the motor 102 and/or the amount of torque generated by the motor 102.

FIG. 4 illustrates the motor assembly 100. The motor 102 comprises a motor housing 104 and an output shaft 106. The first output 108 is in rotational communication or rotationally fixed with the output shaft 106 such that the first output 108 and the output shaft 106 rotate together.

The second output 106 is not rotationally fixed with the output shaft 106. This means that rotation of the output shaft 106 does not cause the second output 110 to rotate with the output shaft 106. The second output 110 is in rotational communication or rotationally fixed with the motor housing 104 such that the second output 110 and the motor housing 104 rotate together. The motor assembly 102 may include an adapter 114 facilitating the connection between the second output 110 and the motor housing 104 so that the motor housing 104 and the second output 110 rotate together.

The motor 102 comprises an armature or rotor 116 that is surrounded by a stator 118, here a pair of magnets. The motor assembly 102 comprises bearings 120, 122, 124 facilitating rotation of the output shaft 106 and motor housing 104. The motor assembly 102 comprises a slip ring 126 for commutating power and/or signals to the motor 102 via the terminals 112.

For the purposes of describing operation of the brake assembly 10 and/or the motor assembly 100, we assume the first output 108 is in communication with the first rotary to linear stage mechanism 28a and/or the first brake piston 20, and the second output 110 is in communication with the second rotary to linear stage mechanism 28b and the second brake piston 22. However, it is understood that in some configurations, the first output 108 may be in communication with the second rotary to linear stage mechanism 28b and/or the second brake piston 22, and the second output 110 may be in communication with the first rotary to linear stage mechanism 28a and/or the first brake piston 20. “In communication”, in at least these contexts, means that movement or rotation of the output 108, 110 causes the corresponding rotary to linear stage mechanism 28a, 28b and/or brake piston 20, 22 to move.

The motor assembly 100 may be operable in at least three operating conditions, namely a first operating condition, a second operating condition, and a third operating condition.

In or during the first operating condition, torque generated by the motor 102 is communicated to the first output 108 so that the first output 108 and the output shaft 106 rotate together. This first condition may occur when a load acting on the second output 110 is greater than a load acting on the first output 108. During this first condition, the second output 110 and thus the motor housing 104 may slow or cease rotating all together.

In or during the first operating condition, as the first output 108 rotates in either an apply or release direction, the first rotary to linear stage mechanism 28a and/or brake piston 20 is moved. More specifically, rotation of the first output 108 in an apply or release direction causes the first spindle 30a to rotate in a corresponding apply or release direction. Rotation of the first spindle 30a in an apply or release direction causes the first nut 32a to move in a corresponding apply direction or a release direction.

When the first nut 32a is moved in the apply direction, the first nut 32a is moved until the first nut 32a contacts the bottom pocket wall 38a, and then continued movement of the first nut 32a in the apply direction causes the first piston 20 and, therefore, either an end of the brake pad 14 (FIG. 1) or the entire brake pad 14 (FIG. 2) to be moved towards and against the brake rotor 18 to create the clamping force.

When the first nut 32a is moved in the release direction, the first nut 32a is moved away from the bottom pocket wall 38a so that the first piston 20 moves away the brake pad 14 so that the end of the brake pad 14 (FIG. 1) or the entire brake pad 14 (FIG. 2) is moved away from the brake rotor 18.

In or during a second operating condition, torque generated by the motor 102 is communicated to the second output 110 so that the second output 110 and the motor housing 104 rotate together. This second condition may occur when a load acting on the first output 108 is greater than a load acting on the second output 110. During this second condition, the first output 108 and thus the output shaft 106 may slow or cease rotating all together.

In or during the second operating condition, as the second output 110 rotates in either an apply or release direction, the second rotary to linear stage mechanism 28b and/or brake piston 22 moves. More specifically, rotation of the second output 110 in an apply or release direction causes the second spindle 30b to rotate in a corresponding apply or release direction. Rotation of the second spindle 30b in an apply or release direction causes the second nut 32b to move in a corresponding apply direction or a release direction.

When the second nut 32b is moved in the apply direction, the second nut 32b is moved until the second nut 32b contacts the bottom pocket wall 38b, and then continued movement of the second nut 32b in the apply direction causes the second piston 22 and, therefore, either an end of the brake pad 16 (FIG. 1) or the entire brake pad 16 (FIG. 2) to be moved against the brake rotor 18 to create the clamping force.

When the second nut 32b is moved in the release direction, the second nut 32b is moved away from the corresponding bottom pocket wall 38b so that the second piston 22 moves away the brake pad 16 so that the end of the brake pad 16 (FIG. 1) or the entire brake pad 16 (FIG. 2) is moved away from the brake rotor 18.

In or during a third operating condition, torque generated by the motor 102 is provided to both of the first output 108 and the second output 110. During this third condition, the output shaft 106 rotates together with the first output 108, and the motor housing 104 rotates together with the second output 110.

The third condition may occur when a load acting on the first output 108 is substantially the same as the load acting on the second output 110. The loads acting on both outputs 108, 110 may be substantially the same when the nuts 32a, 32b are not yet in communication with a bottom wall 38a, 38b of the corresponding piston pocket 26a, 26b. The loads acting on both outputs 108, 110 may be substantially the same when both nuts 32a, 32b are in communication with a bottom wall 38a, 38b of the corresponding piston pocket 26a, 26b. During this condition, the first output 108 and the output shaft 106 may rotate at greater speed than the second output 110 and the housing 104.

In or during the third operating condition, as the first and second outputs 108, 110 rotate in either an apply or release direction, both of the first and the second rotary to linear stage mechanisms 28a, 28b and/or the brake pistons 20, 22 move. More specifically, rotation of the first and second outputs 108, 110 in an apply or release direction causes the corresponding spindles 30a, 30b to rotate in a corresponding apply or release direction. Rotation of the first and second spindles 30a, 30b in an apply or release direction causes the corresponding first and second nuts 32a, 32b to move in a corresponding apply direction or a release direction.

When the first and second nuts 32a, 32b are moved in the apply direction, the nuts 32a, 32b are moved until the nuts 32a, 32b contact the corresponding bottom pocket walls 38a, 38b, and then continued movement of the nuts 32a, 32b in the apply direction causes the corresponding first and second pistons 20, 22 and, therefore, the entire brake pad 14 (FIG. 1) or both brake pads 14, 16 (FIG. 2) to be moved towards against the brake rotor 18 to create the clamping force.

When the first and second nuts 32a, 32b are moved in the release direction, the nuts 32a, 32b are moved away from the corresponding bottom pocket walls 38a, 38b so that the corresponding pistons 20, 22 move away the ends of the brake pad 14 (FIG. 1) or brake pads 14, 16 (FIG. 2) so that the brake pad 14 (FIG. 1) or brake pads 14, 16 (FIG. 2) are moved away from the brake rotor 18.

It should be noted that the during the aforementioned conditions, the first output 108 and the output shaft 106 rotate in an opposite direction than the second output 110 and the motor housing 104. Therefore, one of the rotary to linear stage mechanism 28a, 28b should have a reverse thread. Alternatively, a gear can be provided between one of the outputs and the corresponding rotary to linear stage mechanism 28a, 28b so that even though the outputs 108, 110 rotate in opposite directions during application of the clamping force and opposite directions during release of the clamping force, the spindles can still be rotated in the same directions without having one of the rotary to linear stage mechanisms reverse-threaded.

During one or more of the aforementioned conditions, the load may act on an output 108, 110 when there is a resistance at the rotary to linear stage mechanism 28a, 28b and/or at the brake piston 20, 22. This load or resistance may occur when the corresponding nut 32a, 32b contacts the corresponding bottom wall 38a, 38b. This load or resistance may occur when the brake piston 20, 22 is being moved. This load or resistance may occur when the corresponding brake piston 20, 22 and the corresponding brake pad 14 and/or 16 are moved against the brake rotor 18 to create the clamping force.

The first operating condition, the second operating condition, the third operating condition, or a combination thereof may occur during a brake apply to create the clamping force and during a brake release to release the clamping force. When more than one condition occurs during a brake apply or brake release, the conditions may occur in any order. For example, during a brake apply or brake release, the operating conditions may occur sequentially (first operating condition, second operating condition, then third operating condition). For example, during a brake apply or brake release, the operating conditions may occur reverse sequentially (third operating condition, second operating condition, then first operating condition). For example, during a brake apply or brake release, the operating conditions may occur out of order (third operating condition, first operating condition, then second operating condition; first operating condition, third operating condition, then second operating condition; second operating condition, third operating condition, then first operating condition; second operating condition, first operating condition, then third operating condition). During a brake apply or brake release, one or more of the conditions may repeat themselves until the clamping force is fully created or released.

1) A motor assembly comprising:
a) a motor comprising an output shaft and a motor housing, the motor is adapted to generate torque;
b) a first output in rotational communication with the output shaft such that the first output and the output shaft rotate together; and
c) a second output in rotational communication with the motor housing such that the second output and the motor housing rotate together;
wherein the motor assembly is operable in three operating conditions;
wherein:
i) in a first operating condition, the torque is transmitted to the first output such that the first output and the output shaft rotate together,
ii) in a second operating condition, the torque is transmitted to the second output such that the second output and the motor housing rotate together; and
iii) in a third operating condition, the torque is transmitted to both of the first output and the second output such that the first output and the output shaft rotate together and the second output and the motor housing rotate together.

2) The motor assembly according to claim 1, wherein during one or more of the three operating conditions, when a load acting on the first output becomes higher than a load acting on the second output, the first output slows or ceases to rotate, while the second output continues to rotate.

3) The motor assembly according to claim 1, wherein during one or more of the three operating conditions, when the load acting on the second output becomes higher than the load acting on the first output, the second output slows or ceases to rotate, while the first output continues to rotate.

4) The motor assembly according to claim 1, wherein during the third operating condition, when the load acting on the first output is substantially the same as the load acting on the second output, both of the first output and the second output rotate.

5) The motor assembly according to claim 4, wherein during the third condition, the first output rotates faster than the second output.

6) The motor assembly according to claim 1, wherein the first output and the second output rotate in opposing directions.

7) A vehicle brake assembly comprising the motor assembly according to claim 1.

8) The vehicle brake assembly according to claim 7, wherein the vehicle brake assembly is floating brake system.

9) A motor assembly comprising:
a) a motor;
b) a first output; and
c) a second output;
wherein the motor is adapted to generate torque that is then transmitted to both of the first output and the second output so that both of the first output and the second output rotate; and
wherein when a load at one of the first output and the second output becomes higher than a load at the other one of the first output and the second output, the output with the higher load slows or ceases to rotate, while the output with the lower load continues to rotate.

10) The motor assembly according to claim 9, wherein the first output and the second output are adapted to rotate in opposite directions.

11) The motor assembly according to claim 9, wherein the motor comprises an output shaft, and the output shaft is in rotational communication with the first output; and
wherein when the load at the first output is lower than the load at the second output, the output shaft rotates with the first output, while the second output slows or ceases to rotate.

12) The motor assembly according to claim 9, wherein the motor comprises a motor housing, and the motor housing is in rotational communication with the second output; and
wherein when the load at the second output is lower than the load at the first output, the motor housing rotates with the second output, while the first output slows or ceases to rotate.

13) The motor assembly according to claim 9, wherein during a free running condition when the load at the first output is generally the same as the load at the second output, the first output and the second output both rotate, and
wherein during the free running condition, the first output rotates faster than the second output.

14) A vehicle brake assembly comprising the motor assembly according to claim 9, wherein the first output and the second output are each in communication with a corresponding brake piston.

15) A brake assembly comprising:
a first brake piston;
a second brake piston;
a motor assembly comprising:
a) a motor comprising an output shaft and a motor housing, the motor is adapted to generate torque;
b) a first output in rotational communication with the output shaft, the first output is adapted to move the first brake piston; and
c) a second output in rotational communication with the housing, the second output is adapted to move the second brake piston;
wherein the motor assembly is operable in a first operating condition where the torque is transmitted to the first output such that the first output and the output shaft rotate together.

16) The brake assembly according to claim 15, wherein the motor assembly is operable in a second operating condition where the torque is transmitted to the second output such that the second output and the motor housing rotate together.

17) The brake assembly according to claim 15, wherein the motor assembly is operable in a third operating condition where the torque is transmitted to both of the first output and the second output such that the first output and the output shaft rotate together and the second output and the motor housing rotate together.

18) The brake assembly according to claim 15, wherein when the load is lower at the first output, the output shaft rotates with the first output, while the motor housing and the second output slow or cease to rotate.

19) The brake assembly according to claim 15, wherein when the load is lower at the second output, the motor housing rotates with the second output, while the output shaft and the first output slow or cease to rotate.

20) The brake assembly according to claim 15, wherein during a free running condition when the load at the first output is generally the same as the load at the second output, the first output and the second output both rotate, and
wherein during the free running condition, the first output and the output shaft rotate faster than the second output and the motor housing.
